(19) United States
(12) Patent Application Publication
(10) Pub. No.: US 2024/0368429 A1
(43) Pub. Date: Nov. 7, 2024

(54) LOW STRESS AND TAILORABLE STRESS ADHESIVES FOR BONDING OF SENSITIVE COMPONENTS AND PROCESS FOR CREATING THE SAME

(71) Applicant: The Aerospace Corporation, El Segundo, CA (US)

(72) Inventors: Geena L. FERRELLI, Marina Del Rey, CA (US); Hyun I. KIM, Brea, CA (US); Rafael J. ZALDIVAR, Redondo Beach, CA (US)

(73) Assignee: The Aerospace Corporation, El Segundo, CA (US)

(21) Appl. No.: 18/310,840

(22) Filed: May 2, 2023

(51) Int. Cl. C09J 4/00; C09J 11/06

(52) U.S. Cl. CPC C09J 4/00; C09J 11/06; C09J 2301/416

(57) ABSTRACT

Low stress and tailorable stress adhesives for bonding of sensitive components and a process for using the same are disclosed. The residual curing stress is tailorable based on adherends and with material properties that minimize environmentally induced thermal and hygroscopic distortions. Degraded performance of sensitive optical assemblies may be reduced or eliminated during bonding processes due to residual stress formation of adhesives. The adhesives are characterized by a second mechanism of stress formation other than the tensile stress from shrinkage during curing. Specifically, the adhesive is characterized by a cure gradient through its thickness, causing diffusion of uncured monomer into the more highly crosslinked region. This diffusion causes a compressive stress to form and offset the tensile cure shrinkage stress. The relative amounts of shrinkage and swelling that occur can be tailored to control residual stress formation, and ultimately, to generate a zero-stress bonding adhesive.

### FIELD

The present invention generally pertains to adhesives, and more particularly, to low stress and tailorable stress adhesives for bonding of sensitive components and a process for using the same.

### BACKGROUND

Optical bonding assemblies, for example, are highly sensitive to small distortions. Such distortions can lead to substantial drops in optical performance. As optical tolerances become more stringent with new designs, adhesive bonding has been observed to be a common source of distortion with significant degradation of optical performance. Conventional adhesives used in these applications are mixed, applied, and cured at room temperature (RT). These materials undergo shrinkage during curing, which imparts a residual stress on the bonded components and leads to astigmatism and alignment errors in the assembly. The stress arises from chemical crosslinking during curing that results in a net shrinkage and tensile stress formation. Elevated temperatures necessary to achieve full cure with conventional adhesives also imparts residual stresses, as do changes in dimension of the adhesive due to the absorption/desorption of moisture (e.g., coefficient of moisture expansion (CME)).

Currently, structural adhesives used in these applications attempt to reduce shrinkage by adding inorganic fillers to the adhesives. More compliant adhesives may be used, but this comes at the expense of other performance metrics. Also, high loading significantly increases stiffness of the adhesive, reduces bond strength and increases processing complexities (e.g., rheological profile) and room temperature (RT) cured formulations absorb high levels of moisture, which provides unpredictable performance in space of adhesively bonded structures, for example. Accordingly, improved and/or alternative adhesives may be beneficial.

### SUMMARY

Certain embodiments of the present invention may be implemented and provide solutions to the problems and needs in the art that have not yet been fully solved by existing adhesives. For example, some embodiments pertain to low stress and tailorable stress adhesives for bonding of sensitive components and/or a process for using the same.

In an embodiment, a method for preparing a tailorable stress adhesive includes determining a target stress and strength for the tailorable stress adhesive and determining a photoinitiator concentration of one or more photoinitiators for the tailorable stress adhesive based on the target stress and strength to be combined with a monomer. The method also includes selecting a curing technique and post-curing technique for the tailorable stress adhesive based on the determined target stress and strength. The method further includes curing and post-curing the monomer and the one or more photoinitiators in accordance with the selected curing and post-curing technique.

In another embodiment, a method for preparing a tailorable stress adhesive includes determining a target stress for the tailorable stress adhesive and determining a photoinitiator concentration of one or more photoinitiators for the tailorable stress adhesive based on the target stress to be combined with a monomer. The method also includes selecting a curing technique and post-curing technique for the tailorable stress adhesive based on the determined target stress and curing and post-curing the monomer and the one or more photoinitiators in accordance with the selected curing and post-curing technique. The photoinitiator concentration, monomer, curing technique, and post-curing technique are selected to cause a cure gradient to occur throughout a thickness of the tailorable stress adhesive, causing diffusion of the monomer into a more highly crosslinked region of the tailorable stress adhesive and at least partially offsetting tensile stress from shrinkage of the tailorable stress adhesive during the curing. The photoinitiator concentration is greater than 0% and less than or equal to 10%.

In yet another embodiment, a method for preparing a tailorable stress adhesive includes determining a target stress and strength for the tailorable stress adhesive and determining a photoinitiator concentration of one or more photoinitiators for the tailorable stress adhesive based on the target stress and strength to be combined with a monomer. The method also includes selecting a curing technique and post-curing technique for the tailorable stress adhesive based on the determined target stress and strength and curing and post-curing the monomer and the one or more photoinitiators in accordance with the selected curing and post-curing technique. The photoinitiator concentration is greater than 0% and less than or equal to 10%. The tailorable stress adhesive does not include an inorganic filler.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1A is a graph illustrating the glass transition temperature (Tg) for four Aerospace adhesive formulations and two commonly used adhesives provided by Loctite®, according to an embodiment of the present invention.

FIG. 1B is a graph illustrating the moisture absorption over the square root of time in hours in an environment with a relative humidity (RH) of 100% for Loctite® 9313.

FIG. 2 illustrates surface distortions of a conventional adhesive and a tailored adhesive, according to an embodiment of the present invention.

FIG. 3 illustrates UV-cured epoxy chemical components, according to an embodiment of the present invention.

FIG. 4 is a graph illustrating relaxation modulus over time for four adhesive formulations with different amounts of photoinitiator (PI), according to an embodiment of the present invention.

FIG. 5A is a flowchart illustrating a process for creating low stress and tailorable stress adhesives for bonding of sensitive components, according to an embodiment of the present invention.

FIG. 5B illustrates the tradeoff between low stress and high strength for different types of curing and post-curing, according to an embodiment of the present invention.

Unless otherwise indicated, similar reference characters denote corresponding features consistently throughout the attached drawings.

### DETAILED DESCRIPTION OF THE EMBODIMENTS

Some embodiments of the present invention pertain to low stress and tailorable stress adhesives for bonding of sensitive components and/or a process for using the same. The residual curing stress is tailorable based on adherends and with material properties that minimize environmentally induced thermal and hygroscopic distortions. Degraded performance of sensitive optical assemblies may be reduced or eliminated during bonding processes due to residual stress formation of adhesives. Such embodiments may be suitable for any application requiring low stress bonding, such as optical bonding for next generation telescopes (x-ray, visible light, infrared (IR), etc.), cameras, and other optical systems (e.g., composite-to-core bond, components bonded to a bench (struts), optics bonded within mounts, etc.), microelectronics applications, etc. However, some embodiments may be applied to any suitable application where strength is degraded using conventional adhesives due to buildup in residual stresses of bonded parts during thermal cycling.

Adhesives of some embodiments are characterized by a second mechanism of stress formation other than the tensile stress from shrinkage during curing. Specifically, the adhesive of such embodiments is characterized by a cure gradient through its thickness, causing diffusion of uncured monomer into the more highly crosslinked region. The cure mechanism and the photoinitiator concentration both control the cure gradient, and by understanding the relationship between these, the stress can be controlled. This diffusion causes a compressive stress to form and offset the tensile cure shrinkage stress. The relative amounts of shrinkage and swelling that occur can be tailored to control residual stress formation, and ultimately, to generate a zero-stress bonding adhesive in some embodiments. Comparisons of residual strain for two common optical bonding adhesives (Loctite® 9313 and 9396) and four adhesives developed by The Aerospace Corporation® after cure at RT and 40° C. are shown in Tables 1 and 2 below.

TABLE 1
COMPARISON OF EXISTING ADHESIVES TO LOW STRESS AND
TAILORABLE STRESS ADHESIVES AFTER CURE AT RT

| | Residual Strain (%) after | Relative Comparison to |
|---|---|---|
| Adhesive | RT Cure | Loctite ® 9313 |
| 9313 | 0.07 | 100% |
| 9396 | 0.11 | 157% |
| Aerospace A | 0.01 | 14% |
| Aerospace B | 0.005 | 7% |
| Aerospace C | −0.04 | −57% |
| Aerospace D | −0.05 | −71% |

TABLE 2
COMPARISON OF EXISTING ADHESIVES
TO LOW STRESS AND TAILORABLE STRESS
ADHESIVES AFTER CURE AT 40° C.

| | Residual Strain (%) after | Relative Comparison to |
|---|---|---|
| Adhesive | RT Cure | Loctite ® 9313 |
| 9313 | 0.23 | 100% |
| 9396 | 0.21 | 91% |
| Aerospace A | 0.06 | 26% |
| Aerospace B | 0.10 | 43% |
| Aerospace C | 0.09 | 39% |
| Aerospace D | 0.09 | 39% |

By varying the catalyst/photoinitiator (PI) concentration, the resulting material properties and residual stress can be changed, as shown for adhesives Aerospace A-D. The Aerospace formulations span from tensile to compressive, with Aerospace formulation B being the closest to zero, reducing stresses by more than 90% compared to commonly used Loctite® 9313. Formulations of some embodiments include an epoxy monomer and a PI concentration of 0% to 10%.

Elevated thermal exposure can further increase distortion in the adhesive bond due to further cure shrinkage and creep/stress relaxation phenomena at elevated temperatures. This is seen in Table 2 above. Higher Tg values and minimal Tg shift with elevated thermal exposure are typically desired, and the Aerospace formulations show greater than 50% improvement over the Loctite® formulations.

In addition to residual stress/strain, the material properties of optical bonding adhesives are crucial. Increased glass transition temperature (Tg) and elastic modulus values and a reduction in moisture absorption relate to thermal and hygroscopic performance of the adhesives. Tg is the temperature at which an amorphous polymer changes from a hard/glassy state to a soft/leathery state, or vice versa.

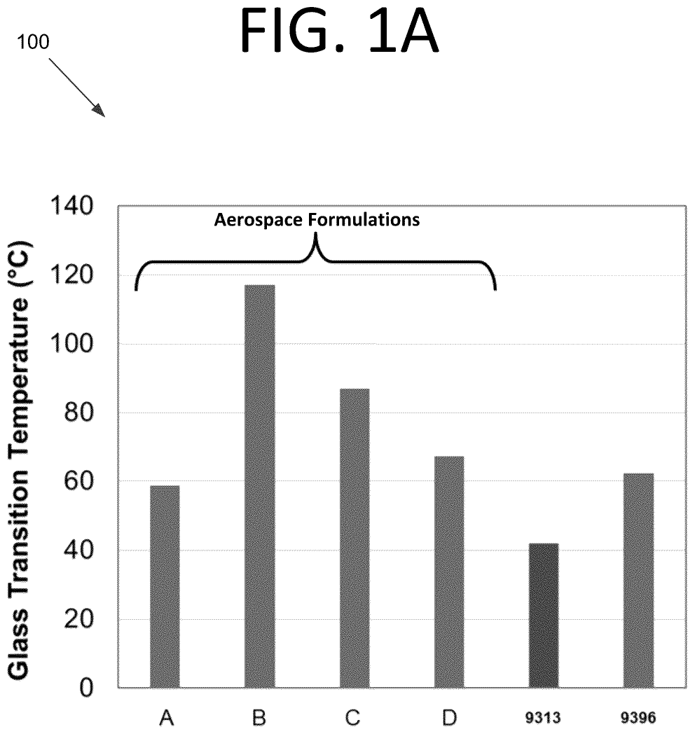

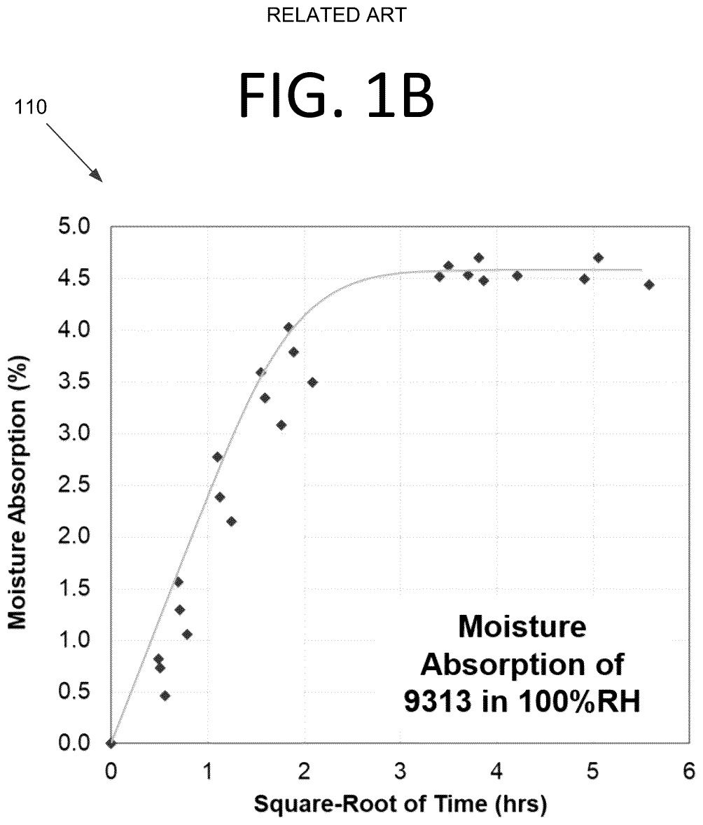

Tg and saturated moisture content are shown in graphs 100, 110 of FIGS. 1A and 1B, respectively, for the four Aerospace adhesive formulations and the two commonly used adhesives provided by Loctite®. Aerospace adhesives A-D are all equivalent to or better than the conventional samples with regards to both metrics. Aerospace scientists have developed low stress adhesives that do not sacrifice hygrothermal stability performance. Also, as seen in FIG. 1A, Tg can be improved by nearly 80° C. from Loctite® 9313 to Aerospace sample B. The moisture absorption of Loctite® 9313 at 100% relative humidity (RH) is shown in FIG. 1B.

Moisture desorption after launch is also associated with dimensional changes. Strain depends on the adhesive moisture content and the CME. Saturated moisture content and CME were measured for the Loctite® adhesives and Aerospace adhesives A-D. See Table 3 below.

TABLE 3
COMPARISON OF CME AND STRAIN
DUE TO 50% RH DRY-OUT

| | | | Relative |
|---|---|---|---|
| | CME | Strain Due to 50% | Comparison to |
| Adhesive | (μm/m/% M) | RH Dry-Out | Loctite ® 9313 |
| 9313 | 4150 | 0.98 | 100% |
| 9396 | 3750 | 1.86 | 190% |
| Aerospace A | 4200 | 0.65 | 66% |
| Aerospace B | 3100 | 0.41 | 42% |
| Aerospace C | 5600 | 0.77 | 79% |
| Aerospace D | 7400 | 1.36 | 133% |

Per the above, Aerospace B reduced hygroscopic stress by more than 50% compared to Loctite® 9313.

New adhesives can be tailored to control the material properties and residual stress of the bonded structure in some embodiments. A series of ultraviolet (UV) cured adhesives can be tailored to the adherents. A high state of cure can be achieved with UV exposure at RT versus the elevated temperature cure required for conventional adhesives. The tailorable adhesives of some embodiments can be cured in non-line-of-sight exposure, allowing for the bonding of clips and/or non-transparent adherends (gamma-cured).

CMEs can be tailored to values lower than state-of-the-art adhesives currently use. More specifically, conventional CME values are typically ˜4000 ppm, potentially being somewhat lower or higher depending on PI concentration. Some systems highly filled with inorganic particles are ˜3000 ppm, similar to Aerospace B. However, while inorganic fillers reduce moisture absorption, adhesives including these fillers are still characterized by same low degree of cure/Tg and susceptibility to creep during thermal exposure, as well as increased stiffness that can exacerbate distortion.

More reliable performance may be provided by using tailorable adhesives for space applications, where moisture dry-out leads to uncertainties in optical performance. Distortion caused by bonding of sensitive optical components and/or dissimilar materials and environmentally-induced distortion caused during thermal exposure and moisture dry-out may be reduced. A long working time for alignment prior to cure may also be provided. Conventional adhesives undergo chemical crosslinking immediately upon mixing and have ˜30-90 minutes of working time before the viscosity is too high. UV adhesive systems do not crosslink until UV radiation is applied, so crosslinking can be delayed until a high UV intensity occurs. A small UV intensity is provided by most room lights that can cause small degrees of crosslinking over the course of days, but the working time of some embodiments is orders of magnitude longer than with conventional adhesives even in the presence of these small UV intensities.

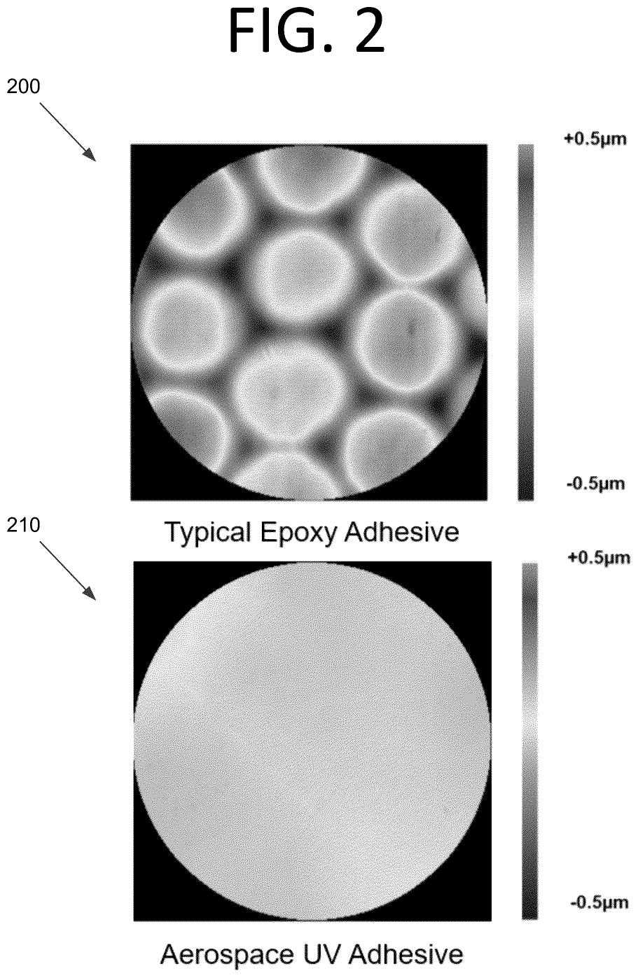

Existing adhesives, such as Loctite® 9313 and 9396, experience deformities during cure. These deformities can cause misalignments for sensitive optical components and other position-sensitive applications. An example is shown in FIG. 2. A conventional adhesive 200 (in this example, Loctite® 9396) experiences deformities of approximately +0.5 to −0.5 micrometers (μm). However, an Aerospace tailored adhesive 210 (in this example, Aerospace C) has a much more uniform surface.

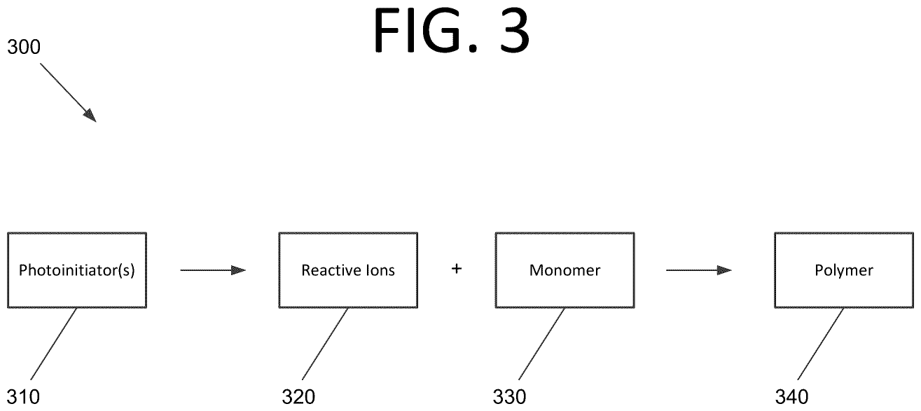

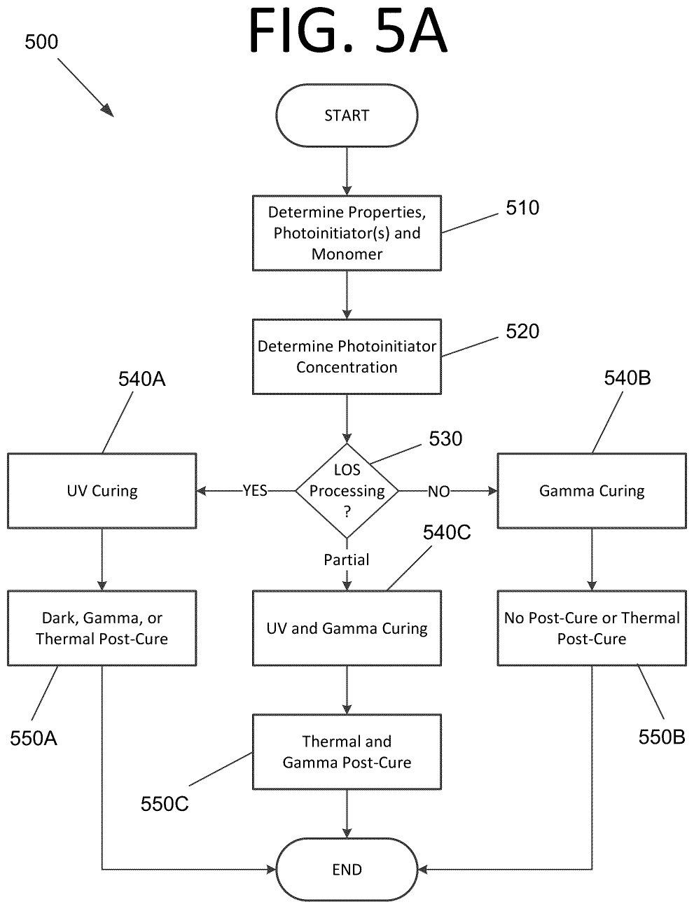

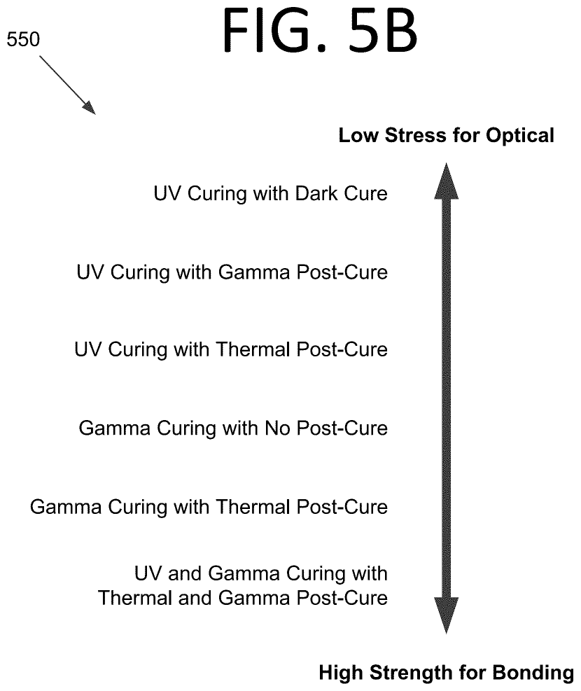

When bonding in optical systems or other applications, it is often desirable to maximize material property stability with small residual curing stresses. UV-cured adhesives of some embodiments can achieve a high cure state with RT processing. FIG. 3 illustrates UV-cured epoxy chemical components 300, according to an embodiment of the present invention. One or more photoinitiators 310 (e.g., a sulfonium salt photoinitiator, an unsaturated copolymerizable photoinitiator, camphorquinone, 4,4′-bis(methylethylamino)benzophenone or another benzophenone photoinitiator, isopropylthioxanthone, 1-hydroxycyclohexyl phenyl ketone, 2,2-dimethoxy-2-phenylacetophenone, 4,4′-bis(diethylamino) benzophenone, 2,2-diethoxyacetophenone, an amine synergist, 2,2-diethoxyacetophenone, any combination thereof, etc.) is exposed to UV light to produce reactive ions 320 (e.g., a Brønsted acid or other free radicals), which interact with a monomer. This results in the desired adhesive polymer 340. Various epoxy and acrylic monomers may be used without deviating from the scope of the invention. These include cycloaliphatic, aromatic, or linear classes, for example. The PI and monomer that are selected may depend on the final adhesive properties that are desired for the application. See FIGS. 5A and 5B, for example.

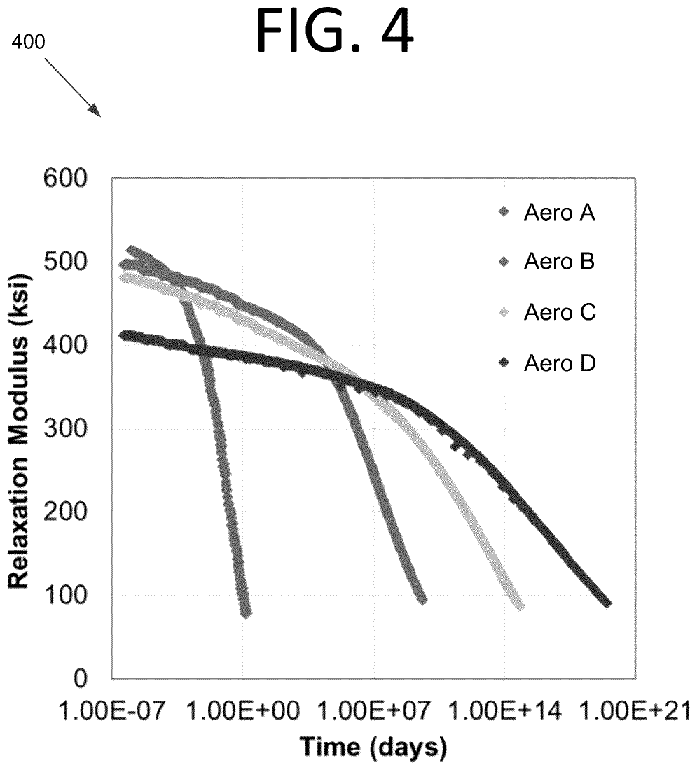

The unique stress relaxation behavior of this system can provide a basis for understanding how to take advantage of a formulation-driven stress relaxation response to tailor residual stresses. FIG. 4 is a graph 400 illustrating relaxation modulus over time in thousands of pounds per square inch (ksi) for four adhesive formulations with different amounts of PI, according to an embodiment of the present invention. The amount of PI in the adhesives was lowest in Aerospace A and highest in Aerospace D, increasing in concentration from Aerospace A to Aerospace B to Aerospace C to Aerospace D. As can the seen, including more PI leads to a slower stress relaxation rate. In addition to the PI concentration (e.g., 0-5%), stress and material properties also depend on the photoinitiation type (e.g., gamma or UV), the duration of the gamma or UV exposure, and the type of post-cure.

FIG. 5A is a flowchart illustrating a process 500 for creating low stress and tailorable stress adhesives for bonding of sensitive components, according to an embodiment of the present invention. The process produces a compressive stress in the adhesive that at least partially offsets the tensile cure shrinkage. The compressive stress is tailorable based on the adherends and with material properties that minimize environmentally-induced thermal and hygroscopic distortions. In FIG. 5A, the combination of PI concentration and curing mechanism control compressive stress formation.

The process begins with determining the desired adhesive properties (e.g., stress-to-strength tradeoff), a monomer, and one or more photoinitiators at 510. A PI concentration for the adhesive is then formulated for these properties at 520. For example, the PI concentration may be determined based on the desired, moisture absorption/CME, stress relaxation rate, Tg, and thermal creep characteristics may be taken into account to determine the PI concentration. If more moisture is desired or higher stiffness is desired for a given application, this may be obtained based on the PI, adhesive, and curing/post-cure process. The Tg is shown in FIG. 1A. Creep is shown in FIG. 4. The CME and moisture content are shown in Table 3.

If line of sight (LOS) processing is desired at 530, UV curing is performed at 540A and a dark post-cure (i.e., the adhesive is allowed to set for an amount of time), a gamma post-cure, or a thermal post-cure is performed at 550B. If LOS processing is not desired at 530, gamma curing is performed at 540B and either no post-cure is performed or a thermal post-cure is performed at 550B. If partial LOS processing is desired at 530, UV LOS curing is performed first, and the structure is then placed in a gamma irradiation chamber to perform gamma non-LOS curing and induce crosslinking in the non-LOS area at 540 C. Thermal and gamma post-curing is then performed at 550 C.

The low stress to high strength tradeoff 550 is shown in FIG. 5B with respect to the different types of curing and post-cure. For stress, “low” values are less than 0.1 ksi. The specific values will depend on the formulation, which is driven by required material properties for the application. Strength is dependent on substrates. UV curing with a dark cure at RT provides the lowest stress, which may make it most suitable for optical applications. UV and gamma curing with a thermal and gamma post-cure induces the highest stress, but provides the highest strength for bonding. The low stress to high strength tradeoff and the application for the adhesive informs the selection of the specific characteristics of process 500.

UV curing at RT may be beneficial where high stability is desired and thermal mismatch is a concern. Thermal mismatch tends to cause a high amount of distortion. Relatively small changes in chemistry were observed to result in large changes in material properties in the process of FIG. 5A, which is not normally the case with thermal curing. By carefully selecting the monomers and photoinitiators, a high degree of variability in the properties of the cured/post-cured adhesive can be achieved. Diffusion of the active photoinitiator increases the cure state, so varying the amount that is used can have a significant effect. See FIG. 4, for example.

Some embodiments provide various advantages over existing adhesives and existing adhesive curing and post-curing processes. A high cure state can be achieved when curing at RT, for example. Conventional adhesives have a low Tg, which makes them susceptible to creep and further distortion during elevated temperature exposures. Conventional adhesives also have low degree of cure, which leads to a high moisture content/CME and a high degree of irreversible moisture absorption.

In some embodiments, no inorganic filler is used. Inorganic fillers reduce moisture absorption and are used in conventional adhesives to attempt to reduce shrinkage. These conventional adhesives with inorganic filler are still characterized by same low degree of cure/Tg and susceptibility to creep during thermal exposure, as well as increased stiffness that can exacerbate distortion.

In some embodiments, a high adhesive strength is achieved. Compliant adhesives demonstrate low stiffness, which translates little to no stress to sensitive applications such as optics. However, these low stiffness adhesives have a relatively low strength and are susceptible to creep. Formulations developed using the process of FIG. 5A, for example, can achieve bond strengths on the same order as conventional structural epoxies.

It will be readily understood that the components of various embodiments of the present invention, as generally described and illustrated in the figures herein, may be arranged and designed in a wide variety of different configurations. Thus, the detailed description of the embodiments of the systems, apparatuses, methods, and computer programs of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method for preparing a tailorable stress adhesive, comprising:
determining a target stress and strength for the tailorable stress adhesive;
determining a photoinitiator concentration of one or more photoinitiators for the tailorable stress adhesive based on the target stress and strength to be combined with a monomer;
selecting a curing technique and post-curing technique for the tailorable stress adhesive based on the determined target stress and strength; and
curing and post-curing the monomer and the one or more photoinitiators in accordance with the selected curing and post-curing technique.

2. The method of claim 1, wherein the curing technique comprises ultraviolet (UV) curing and the post-curing technique comprises dark post-curing, gamma post-curing, or thermal post-curing.

3. The method of claim 1, wherein the curing technique comprises gamma curing and the post-curing technique comprises thermal post-curing.

4. The method of claim 1, wherein the curing technique comprises gamma curing and no post-curing is performed.

5. The method of claim 1, wherein the curing technique comprises performing ultraviolet (UV) curing followed by gamma curing and the post-curing technique comprises performing thermal post-curing and gamma post-curing.

6. The method of claim 1, wherein the photoinitiator concentration, monomer, curing technique, and post-curing technique are selected to cause a cure gradient to occur throughout a thickness of the tailorable stress adhesive, causing diffusion of the monomer into a more highly crosslinked region of the tailorable stress adhesive and at least partially offsetting tensile stress from shrinkage of the tailorable stress adhesive during the curing.

7. The method of claim 1, wherein the photoinitiator concentration is greater than 0% and less than or equal to 10%.

8. The method of claim 1, wherein the tailorable stress adhesive does not include an inorganic filler.

9. The method of claim 1, wherein the cured and post-cured tailorable stress adhesive comprises deformities of less than 0.1 micrometers (μm).

10. The method of claim 1, wherein the one or more photoinitiators comprise a sulfonium salt photoinitiator, an unsaturated copolymerizable photoinitiator, a benzophenone photoinitiator, isopropylthioxanthone, 1-hydroxycyclohexyl phenyl ketone, 2,2-dimethoxy-2-phenylacetophenone, 2,2-diethoxyacetophenone, an amine synergist, 2,2-diethoxyacetophenone, or any combination thereof.

11. The method of claim 1, wherein the monomer comprises an epoxy monomer or an acrylic monomer.

12. A method for preparing a tailorable stress adhesive, comprising:
determining a target stress for the tailorable stress adhesive;
determining a photoinitiator concentration of one or more photoinitiators for the tailorable stress adhesive based on the target stress to be combined with a monomer;
selecting a curing technique and post-curing technique for the tailorable stress adhesive based on the determined target stress; and
curing and post-curing the monomer and the one or more photoinitiators in accordance with the selected curing and post-curing technique, wherein
the photoinitiator concentration, monomer, curing technique, and post-curing technique are selected to cause a cure gradient to occur throughout a thickness of the tailorable stress adhesive, causing diffusion of the monomer into a more highly crosslinked region of the tailorable stress adhesive and at least partially offsetting tensile stress from shrinkage of the tailorable stress adhesive during the curing, and
the photoinitiator concentration is greater than 0% and less than or equal to 10%.

13. The method of claim 12, wherein the curing technique comprises ultraviolet (UV) curing and the post-curing technique comprises dark post-curing, gamma post-curing, or thermal post-curing.

14. The method of claim 12, wherein the curing technique comprises gamma curing and the post-curing technique comprises thermal post-curing.

15. The method of claim 12, wherein the curing technique comprises gamma curing and no post-curing is performed.

16. The method of claim 12, wherein the curing technique comprises performing ultraviolet (UV) curing followed by gamma curing and the post-curing technique comprises performing thermal post-curing and gamma post-curing.

17. The method of claim 12, wherein the tailorable stress adhesive does not include an inorganic filler.

18. The method of claim 12, wherein the one or more photoinitiators comprise a sulfonium salt photoinitiator, an unsaturated copolymerizable photoinitiator, a benzophenone photoinitiator, isopropylthioxanthone, 1-hydroxycyclohexyl phenyl ketone, 2,2-dimethoxy-2-phenylacetophenone, 2,2-diethoxyacetophenone, an amine synergist, 2,2-diethoxyacetophenone, or any combination thereof.

19. A method for preparing a tailorable stress adhesive, comprising:
determining a target stress and strength for the tailorable stress adhesive;
determining a photoinitiator concentration of one or more photoinitiators for the tailorable stress adhesive based on the target stress and strength to be combined with a monomer;
selecting a curing technique and post-curing technique for the tailorable stress adhesive based on the determined target stress and strength; and
curing and post-curing the monomer and the one or more photoinitiators in accordance with the selected curing and post-curing technique, wherein
the photoinitiator concentration is greater than 0% and less than or equal to 10%, and
the tailorable stress adhesive does not include an inorganic filler.

20. The method of claim 19, wherein the curing technique comprises ultraviolet (UV) curing and the post-curing technique comprises dark post-curing, gamma post-curing, or thermal post-curing.

21. The method of claim 19, wherein the curing technique comprises gamma curing and the post-curing technique comprises thermal post-curing.

22. The method of claim 19, wherein the curing technique comprises gamma curing and no post-curing is performed.

23. The method of claim 19, wherein the curing technique comprises performing ultraviolet (UV) curing followed by gamma curing and the post-curing technique comprises performing thermal post-curing and gamma post-curing.

24. The method of claim 19, wherein the photoinitiator concentration, monomer, curing technique, and post-curing technique are selected to cause a cure gradient to occur throughout a thickness of the tailorable stress adhesive, causing diffusion of the monomer into a more highly crosslinked region of the tailorable stress adhesive and at least partially offsetting tensile stress from shrinkage of the tailorable stress adhesive during the curing.

25. The method of claim 19, wherein the one or more photoinitiators comprise a sulfonium salt photoinitiator, an unsaturated copolymerizable photoinitiator, a benzophenone photoinitiator, isopropylthioxanthone, 1-hydroxycyclohexyl phenyl ketone, 2,2-dimethoxy-2-phenylacetophenone, 2,2-diethoxyacetophenone, an amine synergist, 2,2-diethoxyacetophenone, or any combination thereof.
